(19) United States
(12) Patent Application Publication
(10) Pub. No.: US 2002/0196810 A1
(43) Pub. Date: Dec. 26, 2002

(54) Method and system for detecting a network terminal in an ISDN Telecommunications system

(76) Inventors: Veli-Matti Harinen, Oulu (FI); Matti Malo, Oulu (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/183,485

(22) Filed: Jun. 28, 2002

Related U.S. Application Data
(63) Continuation of application No. PCT/FI00/01154, filed on Dec. 28, 2000.

(30) Foreign Application Priority Data
Dec. 30, 1999 (FI) 19992831

(51) Int. Cl. H04J 3/22

(52) U.S. Cl. 370/469; 370/522

(57) ABSTRACT

The invention relates to a method and a system for detecting the functional status of an ISDN network terminal while establishing a connection from the exchange to the network terminal by means of messages to be transferred between different protocol layers.

The invention relates to telecommunication systems. In particular the invention relates to a method in which during the connection set-up of an integrated services digital network (ISDN, Integrated Services Digital Network) it is detected whether the network terminal is defected. The connection set-up is started from the exchange to the network terminal.

### PRIOR ART

The use of an ISDN network in telecommunication is becoming common. The basic access of an ISDN network contains one signaling channel, the D-channel, with the transfer rate of 16 Kbps, and two B-channels with the total transfer rate of 128 Kbps. The primary rate access of an ISDN network contains one D-channel with the transfer rate of 64 Kbps, and 30 B-channels. The theoretical maximum transfer rate of an ISDN interface visible to the user is 1920 Kbps. The ISDN interface consists of a series of the ITU-T and ETSI standards. For example, the maintenance of an ISDN interface is defined in the ITU-T standards I.601-I.605 and the cause values of the ISDN interface in the ITU-T recommendation Q.850. The network terminal is usually the digital telephone or the network adapter of the ISDN network, if the ISDN interface is connected to a computer.

The architecture of an ISDN network is described as a layer protocol model which resembles the OSI model (OSI, Open Standards Interconnection) the most significant layers of which are the three lowermost layers. The network layer (third layer) of the architecture of an ISDN network, which is defined in the standard ETS 300 102, implements the setup and setdown of the network connections. Beneath the network layer is the data link layer (second layer), which is defined in the standard ETS 300 125 and which takes care of maintaining the connection between two network components. Beneath the data link layer there is the physical layer (first layer). The physical layer is either a basic access, defined in the standard ETS 300 012 or a primary rate access, defined in the standard ETS 300 011. The standards ETS 300 012 and ETS 300 011 define the physical features of the circuits of an ISDN network, such as connectors, cable types and signaling levels.

One specific problem is becoming the identification of the network terminal. If the connection set-up with an ISDN interface is unsuccessful, the connection set-up is set down, and a notification thereof is sent. The message is a cause value 18 “No user responding” as defined in the ETS 300 102-1 standard. It must be noticed that the message is sent both in a situation where the user cannot be reached and in a situation where the network terminal or the connection is corrupted. Therefore, it cannot be judged by the message whether the connection is corrupted or not, in which case in a possible failure case the re-establishment of the connection is delayed. This may cause significant losses to the connection provider.

The maintenance of an ISDN interface is troublesome. The interface must be monitored so that it may be made sure of the fact that it is functioning. If the interface is not constantly loaded, it is very hard to know whether the interface is working or not. On the other hand, it is possible to connect to the interface a device which enables one to make sure of the fact that the interface is functioning, but the aforementioned method is troublesome and time consuming.

There is no solution previously known that would have solved the aforementioned problems. Before, if the connection set-up was not successful within the expected response time, then the connection was simply set down. No informative message about the connection set-down was sent to the network layer of the ISDN network. In that case, it had to be made sure of the operating of the connection by a separate failure detection device connected to the interface.

The objective of the present invention is to eliminate the drawbacks referred to above or significantly to alleviate them. A further objective of the present invention is to enable one to detect the operating of the network terminal quickly and cost effectively in such a case when a connection is being established with an ISDN interface. The invention enables one to get a more exact picture of the cause value of the connection set-down for the compiling of statistics of the exchange and for the A-subscriber.

### SUMMARY OF THE INVENTION

The invention makes it possible easily to detect the operating of a network terminal during the connection set-up of an ISDN network.

The invention relates to a method in which a connection is first attempted to establish from the exchange to the network terminal. During the connection set-up, a message is sent between the protocol layers of the ISDN network. If the first layer (physical layer) detects that the network terminal or the connection is corrupted, then the first layer sends a message to the second layer (data link layer). The second layer for its part sends the message further on to the third layer (network layer), which sets down the connection set-up and sends a message informing about the connection set-down to the upper protocol layer.

The physical protocol layer detects that the network terminal cannot be reached, when the maintenance test or an earlier attempt to activate the physical layer has been unsuccessful. On the other hand, the physical protocol layer finds outs that the network terminal cannot be reached also in a case when there is an attempt to establish a connection with a subscriber line the activating of the physical layer of which is unsuccessful.

If the physical layer detects that the network terminal cannot be reached, the connection set-up is set down. In that case, a message is sent through the different protocol layers of the ISDN network to the network layer, which sends the message further on to the A-subscriber, where the setdown of the connection set-up is given a reason by a cause value 27 “Destination out of order” as defined in the standard ETS 300 102-1. On the other hand, a DL_RELEASE message is used to inform about the connection set-down from the data link layer to the network layer. The physical layer for its part informs the data link layer of the connection set-down by means of a PH₁₃ DEACTIVATE message. The messages DL_RELEASE- and PH₁₃ DEACTIVATE are defined in the standards ETS 300 125.

For the connection set-up and connection set-down between two physical layers, there are an activation request (AR, Activation Request), an unnumbered acknowledge indication (UAI, Unnumbered Acknowledge Indication) and an activation indication (AI, Activation Indication) used. The aforementioned messages are defined in the standards ETS 300 012 and ETS 300 011. The purpose of the activation request is to establish a connection between the network terminal of an ISDN network and the exchange. The unnumbered acknowledge indication is used to inform about the fact that the message has been received. The activation indication is sent after the connection has been activated. The aforementioned messages are sent from the signaling unit, which is usually located in the exchange.

In an embodiment, the A-subscriber tries to call the B-subscriber. The A-subscriber dials the B-subscriber number, in which case between the telephone of the ISDN network and the exchange messages are sent that are needed in the call establishment. The network terminal of the B-subscriber is defective, in which case the call setup is not successful. The call is released, and a message “Destination out of order” is sent in the released message of the call as described in the invention.

As compared with prior art, the present invention provides the advantage that it makes it possible to detect the lacking of the network terminal or the corruption of the connection quickly enough. The invention is very well integrated with the existing integrated digital services network system, in which case each connection set-up contains the checking of the connection and the network terminal. Therefore, it is seldom needed to check the functional status of the link connection. It is also easy to monitor the functional status of the interface because the control unit is promptly informed about the inoperative interfaces. In that case, saves are made in the maintenance costs of an ISDN interface, since the work contribution of the monitoring personnel may be concentrated on the inoperative interfaces.

### LIST OF DRAWINGS

In the following section, the invention will be described by the aid of the attached examples of its embodiments with reference to the attached drawing, in which

FIG. 1 represents a system in accordance with the invention;

FIG. 2 is a flow chart illustrating a method in accordance with the invention;

FIG. 3 represents an embodiment in accordance with the invention;

FIG. 4 represents a signaling diagram in accordance with the invention;

FIG. 5 represents a protocol diagram in accordance with the invention.

### DETAILED DESCRIPTION OF THE INVENTION

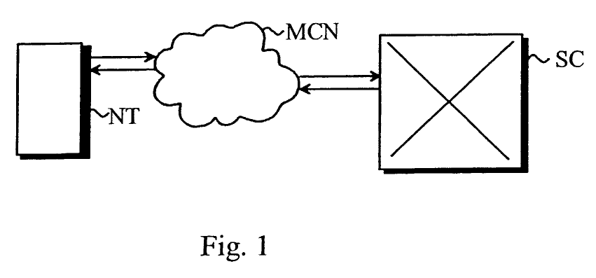

FIG. 1 represents one system in accordance with the invention. The network terminal NT has been connected via the telecommunication network MCN to the exchange SC. Both the network terminal NT and the exchange SC contain a protocol stack of an ISDN network by means of which a connection is established between the exchange SC and the network terminal NT.

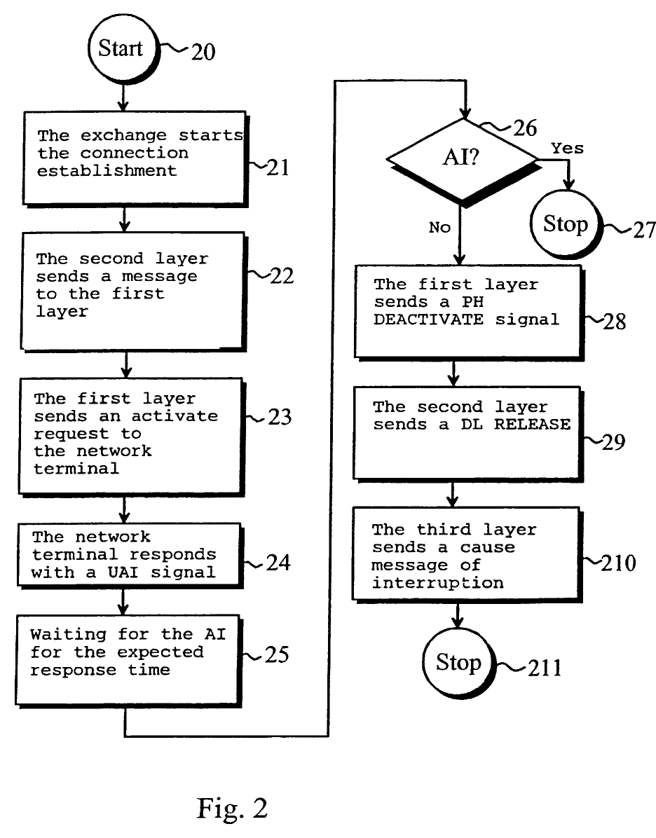

FIG. 2 represents one diagram of a method of the invention. In the example, the exchange starts a connection set-up with the network terminal which has been connected to the ISDN network, block 21. In that case, in the exchange, the third layer sends a message to the second layer, which for its part informs the first layer about the connection set-up, blocks 22 and 23. At first, a line is activated, so the first layer sends an activate request (AR, Activate Request) to the network terminal. If the attempt to activate the U-interface of the network terminal is successful, then the network terminal responds by sending an unnumbered acknowledgement indication (UAI, Unnumbered Acknowledge Indication), block 24. Further it is waited for the activation of the S/T interface and the activate indication (AI, Activate Indication). If the activate indication is not received within a predetermined time, then the terminal device is out of the S/T interface or defective, in which case a PH₁₃ DEACTIVATE message is sent to the second layer, blocks 26 and 28. The second layer sends a DL_RELEASE message further on to the third layer, which for its part sends a cause message of interruption and sets down the connection set-up, blocks 29 and 210.

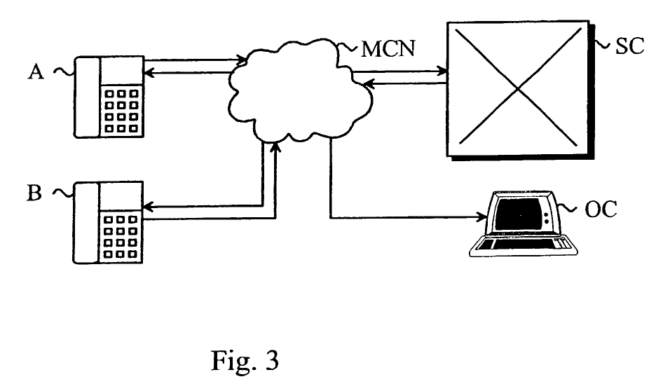

FIG. 3 represents one embodiment in accordance with the invention. The subscriber A calls the subscriber B via the telecommunication network MCN. The call is connected by the exchange SC, which detects that the terminal device B is defective as shown by the invention. The operator OC of the telecommunication network is informed about the defective terminal device by a message. At one step of the connection set-up of the embodiment of the invention, the terminal device is waiting for an acknowledgement for the primitive of the second layer (SABME, Set Asynchronous Reduced Mode Extended). If the acknowledgement is not received within a predetermined time, then it is detected that the connection is corrupted. If the exchange sends a call (SETUP) to the subscriber line, it may be judged that the exchange has not detected that the connection is corrupted. In that case, the terminal device sets down the connection set-up using the cause value 27 “Destination out of order” as defined in the ETS 300 102-1 standard, in which case the exchange is informed of the corruption of the connection. In one embodiment of the invention, the measurement started by the exchange detects an interruption between the exchange and the network terminal. In that case, if there is an attempt to call the subscriber line, then the exchange releases the call backwards using the cause value “Destination out of order” without offering a call to a corrupted subscriber line.

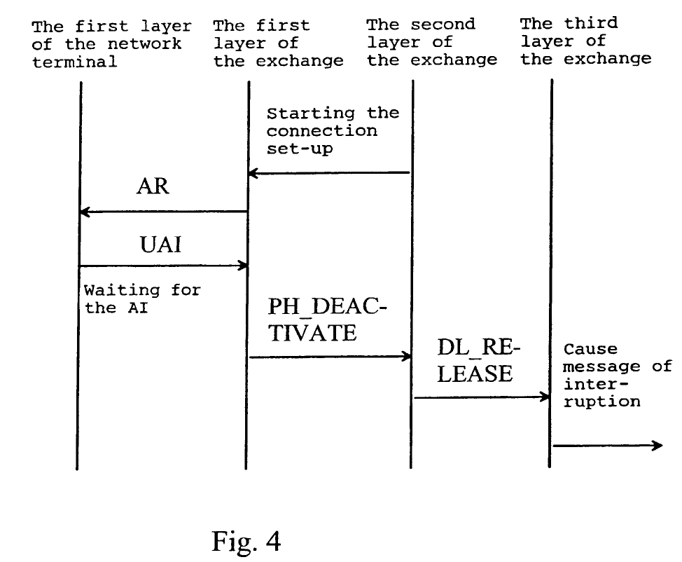

FIG. 4 represents one signaling diagram in accordance with the invention. The connection set-up proceeds as described in FIG. 2. At first in the figure, there is the signal of the connection set-up showing by means of which the second layer informs the first layer about the connection set-up. After this, the first layer sends an activate request AR to the first layer of the network terminal which the network terminal responds by an unnumbered acknowledgement indication UAI. Next, it is waited for the activate indication AI, and if the activate indication AI is not received within a predetermined time, then a PH₁₃ DEACTIVATE signal is sent from the first layer to the second layer. Further the second layers sends a DL_RELEASE signal to the third layer to which the third layer reacts by sending a cause signal of interruption to the upper protocol layer.

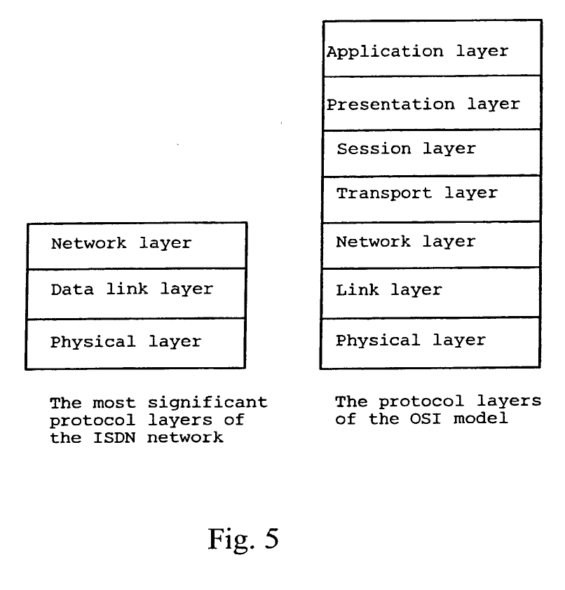

FIG. 5 represents one protocol diagram in accordance with the invention. The architecture of an ISDN network resembles the OSI model (OSI, Open Standards Interconnection). The uppermost layer of the most significant layers of the architecture of the ISDN network is the network layer which takes care of the setup and setdown of the network connections. Beneath the network layer is the data link layer (second layer), which is defined in the standard ETS 300 125 and which takes care of maintaining the connection between two network components. Beneath the data link layer there is the physical layer, which is either a basic access as defined in the standard ETS 300 012 or a primary rate access as defined in the standard ETS 300 011. The standards define the physical features of the circuits of the ISDN network, such as connectors, cable types and signaling levels. The figure represents also the correspondence of the protocol layers of the ISDN network with the protocol layers of the OSI model. The four uppermost layers of the OSI model are the application layer, presentation layer, transport layer and session layer. The lower layers of the OSI model, the network layer, link layer and physical layer, form a frame structure to the protocol layers of the ISDN network.

The invention is not restricted merely to the examples of its embodiments referred to above, instead many variations are possible within the scope of the inventive idea defined by the claims.

1. A method for detecting the network terminal in a telecommunication system comprising:
a telecommunication network (MCN);
an exchange (SC) which has been connected to the telecommunication network (MCN);
a network terminal (NT) which has been connected to the telecommunication network (MCN);
a physical protocol layer;
a data link protocol layer which has been arranged on the top of the physical protocol layer; and
a network protocol layer which has been arranged on the top of the data link layer; in which method:
the connection set-up is started from the exchange (SC) to the network terminal(NT),
characterised in that the method comprises the steps of:
sending a message from the physical protocol layer to the data link layer, if the physical protocol layer detects that the connection set-up with the network terminal (NT) fails;
sending a message from the data link protocol layer to the network protocol layer, when the data link protocol layer receives from the physical protocol layer a message informing that the connection set-up with the network terminal (NT) fails; and
sending a released message from the network protocol layer to the upper protocol layer and setting down the connection, when the network protocol layer receives from the data link protocol layer a message informing that the connection set-up with the network terminal (NT) fails.

2. A method as defined in claim 1, characterised in that it is detected in the physical protocol layer that the connection set-up with the network terminal (NT) is unsuccessful, when the maintenance test fails.

3. A method as defined in claim 1 or 2, characterised in that it is detected in the physical protocol layer that the connection set-up with the network terminal (NT) is unsuccessful, when an earlier attempt to activate the physical protocol layer has been unsuccessful.

4. A method as defined in claim 1, 2, or 3, characterised in that it is detected in the physical protocol layer that the connection set-up with the network terminal (NT) is unsuccessful, when the attempt to activate the physical layer fails while establishing the connection.

5. A method as defined in claim 1, 2, 3, or 4, characterised in that in order to inform two physical protocol layers, an activate request (AR Activate Request) as defined in the standards ETS 300 012-1 and ETS 300 125, an unnumbered acknowledgement indication (UAI, Unnumbered Acknowledge Indication) and an acknowledgement indication (AI, Acknowledge Indication) are used.

6. A method as defined in claim 1, 2, 3, 4, or 5, characterised in that in order to inform the physical protocol layer and the data link protocol layer, a PH₁₃ DEACTIVATE signal is used that is defined in the standard ETS 300 125.

7. A method as defined in claim 1, 2, 3, 4, 5, or 6, characterised in that in order to inform the data link protocol layer and the network protocol layer, a DL_RELEASE signal is used as defined in the standard ETS 300 125.

8. A method as defined in claim 1, 2, 3, 4, 5, 6, or 7, characterised in that a message as defined in the standard ETS 300 012-1 “Destination out of order” is used to inform about the inoperative state of the network terminal (NT), when the connection is set down.

9. A method as defined in claim 1, 2, 3, 4, 5, 6, 7, or 8, characterised in that a cause message of interruption is used to inform about the inoperative state of the network terminal (NT), when the connection is set down.

10. A system for detecting the network terminal in a telecommunication system comprising:
a telecommunication network (MCN);
an exchange (SC) which has been connected to the telecommunication network (MCN);
a network terminal (NT) which has been connected to the telecommunication network (MCN);
a physical protocol layer;
a data link protocol layer which has been arranged on the top of the physical protocol layer; and
a network protocol layer which has been arranged on the top of the data link layer; in which system:
the connection set-up is started from the exchange (SC) to the network terminal(NT),
characterised in that the method comprises:
signaling unit from which a signal is sent, when it is detected that the connection set-up with the network terminal (NT) is unsuccessful.

11. A system as defined in claim 10, characterised in that the exchange (SC) is the exchange of the ISDN network (ISDN, Integrated Services Digital Network).

12. A system as defined in claim 10 or 11, characterised in that the network terminal (NT)is the network terminal of the ISDN network (ISDN, Integrated Services Digital Network).

13. A system as defined in claim 10, 11, or 12, characterised in that the physical protocol layer, data link protocol layer and the network protocol layer are the protocol layers of the ISDN network (ISDN, Integrated Services Digital Network).
